(19) United States
(12) Patent Application Publication
(10) Pub. No.: US 2011/0055010 A1
(43) Pub. Date: Mar. 3, 2011

(54) Enabling High Performance Ad Selection

(76) Inventors: Amir Behroozi, Saratoga, CA (US); Arun Kejariwal, San Jose, CA (US); Sapan Panigrahi, Castro Valley, CA (US)

(21) Appl. No.: 12/552,252

(22) Filed: Sep. 1, 2009

(51) Int. Cl. G06Q 30/00; G06Q 10/00; G06F 17/30

(52) U.S. Cl. 705/14.52; 707/E17.005; 705/1.1

(57) ABSTRACT

A method and a system are provided for enabling high performance ad selection. In one example, the system receives an ad. A relevance of the ad needs to be determined. The relevance is a function of one or more computational intensive functions. A computational intensive function is a function that requires more than trivial processing. The system identifies one or more arguments of the computational intensive functions that are within a fixed range. The system generates a tableau based on the one or more arguments that are within a fixed range. The tableau is configured to benefit run-time performance of an ad selection process whenever the computer uses the pre-generated tableau during run-time instead of calculating one or more computational intensive functions.

### FIELD OF THE INVENTION

The invention relates to online advertising. More particularly, the invention relates to enabling high performance ad selection for online advertising.

### BACKGROUND

The revenue of the advertising industry has been consistently increasing over the 7 years since the year 2002. Most notably, the rate of increase of the revenue of online advertising has been the maximum among all the various mediums. This trend is expected to persist in future.

Over the years, several models have been proposed online advertising. Some of the most commonly known models are the following: CPV (Cost Per Visitor) and CPC (Click Per Click, also known as Pay Per Click). Under CPV, an advertiser pays for the delivery of a targeted visitor to the advertiser's website. Under CPC, advertisers are charged only when the consumer clicks on the advertisement.

The above advertising models do not yield the best bang-for-the-buck for the advertisers. This coupled with increasing competition has paved way to performance-based advertising models, whereby an advertiser can directly measure users actions that result from the advertisement. Some of the commonly used performance-based advertising models are the following: CPI (Click Per Impressions), CPL (Cost Per Lead), CPA (Click Per Action), and CPE (Click Per Engagement). Under CPI (Click Per Impressions), advertisers are charged for impressions (e.g., the number of times people view an advertisement). Under CPL (Cost Per Lead), advertisers pay only for qualified leads as opposed to clicks or impressions and are at the pinnacle of the online advertising ROI hierarchy. Under CPA (Click Per Action), the advertiser pays only for the amount of users who complete a transaction, such as a purchase or sign-up. CPE (Click Per Engagement) is a form of CPA, wherein advertising impressions are free and advertisers pay only when a user engages with their specific ad unit.

Such models employ sophisticated analytics. For example, these models use varied information such as behavioral, contextual, geo, and local time information to determine the most relevant ad. Furthermore, it has been found that two-thirds of senior marketers expect 20 percent of ad revenue to move away from impression-based sales, in favor of action-based models within three years.

The above has led to the development of sophisticated ad ranking and selection algorithms. These algorithms rank the candidate ads based on wide variety of metrics as mentioned above. Often these algorithms use computationally expensive functions, such as exponential and logarithmic functions. It has been shown, using a widely-used compiler (e.g., the GNU Compiler Collection) and real hardware (e.g., the quad-core Xeon), show that such functions account for a large percentage of the run time during ad ranking. Consequently, the use of such functions induces a trade-off between run-time performance and ad relevance. In other words, unfortunately, improving ad relevance via the use of sophisticated models discussed above adversely impacts the latency of the ad server. The latter has direct implications on the bottom line (e.g., cost per ad) of a company like Yahoo®.

### SUMMARY

What is needed is an improved method having features for addressing the problems mentioned above and new features not yet discussed. Broadly speaking, the invention fills these needs by providing a method and a system for enabling high performance ad selection.

In a first embodiment, a computer-implemented method is provided for enabling ad selection. The method comprises at least the following: identifying, at a computer, one or more computational intensive functions, and wherein a computational intensive function requires more than trivial processing to execute; identifying, at a computer, one or more arguments of the computational intensive functions that are within a fixed range; generating, at a computer, a tableau for the one or more arguments that stores a solution for the computational intensive functions; receiving, at a computer, a request to select a message (e.g., ad); and determining, at a computer, a message to select by accessing the tableau to retrieve a solution for the one or more computational intensive functions with an argument within the fixed range.

In a second embodiment, a system is provided for enabling ad selection. The system comprises at least a server system. The server system is configured for at least the following: identifying, at a computer, one or more computational intensive functions, and wherein a computational intensive function requires more than trivial processing to execute; identifying, at a computer, one or more arguments of the computational intensive functions that are within a fixed range; generating, at a computer, a tableau for the one or more arguments that stores a solution for the computational intensive functions; receiving, at a computer, a request to select a message (e.g., ad); and determining, at a computer, a message to select by accessing the tableau to retrieve a solution for the one or more computational intensive functions with an argument within the fixed range.

In a third embodiment, a computer readable medium comprising one or more instructions for enabling ad selection. The one or more instructions are configured for causing the one or more processors to perform the following steps: identifying, at a computer, one or more computational intensive functions, and wherein a computational intensive function requires more than trivial processing to execute; identifying, at a computer, one or more arguments of the computational intensive functions that are within a fixed range; generating, at a computer, a tableau for the one or more arguments that stores a solution for the computational intensive functions; receiving, at a computer, a request to select a message (e.g., ad); and determining, at a computer, a message to select by accessing the tableau to retrieve a solution for the one or more computational intensive functions with an argument within the fixed range.

The invention encompasses other embodiments configured as set forth above and with other features and alternatives. It should be appreciated that the invention can be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a high-level block diagram of a system for enabling high performance ad selection, in accordance with some embodiments;

FIG. 2 illustrates the storage of discretized values into a tableau, in accordance with some embodiments;

FIG. 3 is a distribution of frequencies arguments to the computational intensive functions, in accordance with some embodiments;

FIG. 4 is a flowchart of a method for enabling high performance ad selection, in accordance with some embodiments; and

FIG. 5 is a diagrammatic representation of a network, including nodes that may comprise a machine within which a set of instructions may be executed, in accordance with some embodiments.

### DETAILED DESCRIPTION

An invention is disclosed for a method and a system for enabling high performance ad selection. Numerous specific details are set forth in order to provide a thorough understanding of the invention. It will be understood, however, to one skilled in the art, that the invention may be practiced with other specific details.

### Definitions

Some terms are defined below in alphabetical order for easy reference. These terms are not rigidly restricted to these definitions. A term may be further defined by its use in other sections of this description.

“Ad Server” is a server that is configured for serving one or more ads to consumer devices. An ad server is preferably controlled by a publisher of a website and/or an advertiser of online ads. A server is defined below.

“Ad Taxonomy” means a map of how a publisher/advertiser may categorize ads for an ad campaign. An ad taxonomy may be a hierarchy of static nodes of a static ad taxonomy, or may be a hierarchy of dynamic facets of a dynamic ad taxonomy.

“Advertisement” means a paid announcement, as of goods or services for sale, preferably on a network, such as the Internet. An advertisement may also be referred to as an ad or a message.

“Advertiser” means an entity that is in the business of marketing a product and/or a service to consumers. An advertiser may include without limitation a seller and/or a third-party agent for the seller. An advertiser may also be referred to as a messaging customer.

“Application server” is a server that is configured for running one or more devices loaded on the application server. For example, an application server may be configured for running a device configured for enabling high performance ad selection.

“Client” means the client part of a client-server architecture. A client is typically a consumer device and/or an application that runs on a consumer device. A client typically relies on a server to perform some operations. For example, an email client is an application that enables a consumer to send and receive e-mail via an email server. The computer running such an email client may also be referred to as a client.

“Computational intensive function” means a function that requires more than trivial processing to execute. Examples of a computational intensive function include without limitation an exponential function and a logarithmic function. Computational intensive functions are preferably supported in mathematical libraries. Examples of such mathematical libraries include without limitation libm (from the GNU Compiler Collection) or Boost C++ libraries.

“Consumer” means a user of a consumer device. A consumer is typically a person who seeks to acquire a product or service. For example, a consumer may be a woman who is browsing Yahoo!® Shopping for a new cell phone to replace her current cell phone. The term “consumer” may refer to a consumer device, depending on the context.

“Consumer device” (e.g., “computer” or “consumer computer” or “client” or “server”) means a single computer or to a network of interacting computers. A consumer device is a computer that a consumer may use to communicate with a data distributor and/or a network, among other things. A consumer device is a combination of a hardware system, a software operating system and perhaps one or more software application programs. Examples of a consumer device include without limitation a laptop computer, a palmtop computer, a smart phone, a cell phone, a mobile phone, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Data distributor” means an entity that seeks to obtain events. Examples of a data distributor include without limitation an advertiser and an advertiser agent.

“Database” means a collection of data organized in such a way that a computer program may quickly select desired pieces of the data. A database is an electronic filing system. In some instances, the term “database” is used as shorthand for “database management system”.

“Device” means hardware, software or a combination thereof. A device may sometimes be referred to as an apparatus. Examples of a device include without limitation a software application such as Microsoft Word®, a laptop computer, a database, a server, a display, a computer mouse, and/or a hard disk.

“Event” means data related to an action carried out by a consumer. Examples an event include without limitation click information, login information, and/or search information, among other types of information.

“Event stream” means a data stream of actions that are carried out by one or more consumers. For example, a data distributor may receive an event stream from a web server that receives events from consumers.

“Marketplace” means a world of commercial activity where products and/or services are browsed, bought and/or sold. A marketplace may be located over a network, such as the Internet. A marketplace may also be located in a physical environment, such as a shopping mall.

“Message” means advertisement or ad. “Messaging” means advertising. “Messaging customer” means advertiser.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a web page having content and/or ads.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“Web browser” means any software program which can display text, graphics, or both, from web pages on web sites. Examples of a web browser include without limitation Mozilla Firefox® and Microsoft Internet Explorer®.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific web site, or any document obtainable through a particular URL (Uniform Resource Locator).

“Web server” is a server configured for serving at least one web page to a web browser. An example of a web server is a Yahoo® web server. A server is defined above.

“Web site” means at least one web page, and more commonly a plurality of web pages, virtually connected to form a coherent group.

### I.

### Overview of Architecture

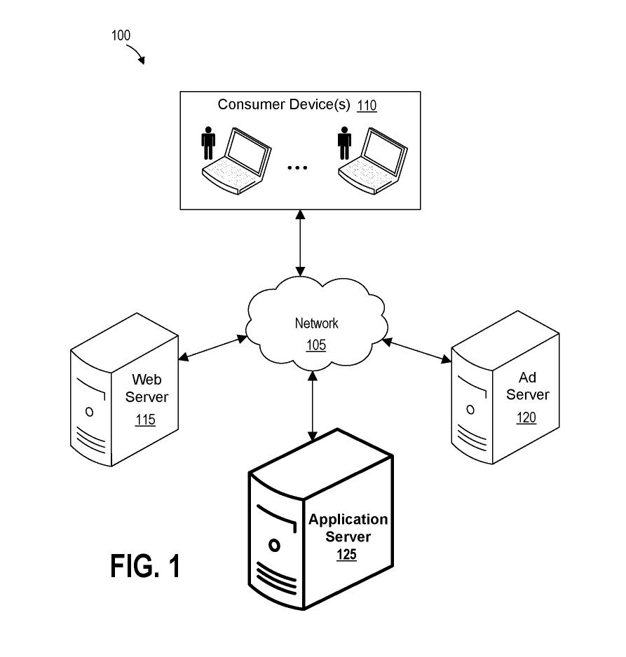

FIG. 1 is a high-level block diagram of a system 100 for enabling high performance ad selection, in accordance with some embodiments. The network 105 couples together one or more consumer devices 110, a web server 115, an ad server 120 and an application server 125. The network 105 may be any combination of networks, including without limitation the Internet, a local area network, a wide area network, a wireless network and/or a cellular network.

Each consumer device 110 includes a single computer or a network of interacting computers. Examples of a consumer device include without limitation a laptop computer, a palmtop computer, a smart phone, a cell phone and a mobile phone. A consumer communicates over the network 105 by using a consumer device 110. A consumer may be, for example, a person browsing or shopping in a marketplace on the Internet.

The application server 125 is a server that is configured for running one or more devices loaded on the application server 125. For example, an application server may be configured for running a device configured for enabling high performance ad selection. The application server 125 preferably carries out the more important steps of the system 100 for enabling high performance ad selection.

The web server 115 is a server configured for serving at least one web page to a web browser. The web 115 server may also provide consumer behavior data to the application server 125 and/or the ad server 120 for analyzing purposes. An example of a web server 115 is a Yahoo® web server.

The ad server 120 is a server that is configured for serving one or more ads to the consumer devices 110. The ad server 120 is preferably controlled by a publisher of a website and/or an advertiser of online ads. A publisher is an entity that publishes, on the network 105, a web page having content and/or ads. An advertiser is an entity that is seeking to market a product and/or a service to consumers at the consumer devices 110. Examples of a publisher/advertiser 120 include without limitation Yahoo!®, Amazon and Nike.

The configuration of the system 100 in FIG. 1 is for explanatory purposes. There are numerous other configurations in other embodiments that are possible. For example, the ad server 120 and the application 125 may be aggregated into one computing system. As another example, each server may be a system of multiple servers. As still another example, the system 100 may include a database system (not shown) configured for storing data and coupled to the network 105. There are many other configurations for the system 100 that are feasible as well.

### II.

### Overview of Enabling High Performance Ad Selection

The system is configured for enabling high performance ad selection. As described above, some traditional systems have sophisticated ad ranking and selection algorithms. These algorithms rank the candidate ads based on wide variety of metrics as mentioned above. Often these algorithms use computationally expensive functions, such as exponential and logarithmic functions. It has been shown, using a widely-used compiler (e.g., the GNU Compiler Collection) and real hardware (e.g., the quad-core Xeon), show that such functions account for a large percentage of the run time during ad ranking. Consequently, the use of such functions induces a trade-off between run-time performance and ad relevance. In other words, unfortunately, improving ad relevance via the use of sophisticated models discussed above adversely impacts the latency of the ad server. The latter has direct implications on the bottom line (e.g., cost per ad) of a company like Yahoo®.

Fortunately, the present system is configured for facilitating the deployment of sophisticated advertising models with lower computational cost and without any adverse impact on the run-time performance.

The evaluation of relevance of a candidate ad can be represented as Equation 1 below:

Relevance (ad)=F(x, y, f(u), g(v), . . . ) Equation 1. Relevance of a candidate ad.

The values u, v, x and y are values that correspond to information pertaining to various dimensions such as context (discussed above). The functions f and g are computational intensive functions. Examples of such computational intensive functions include without limitation exponential functions and logarithmic functions. The computational intensive functions are preferably supported in mathematical libraries. Examples of such mathematical libraries include without limitation libm from the GNU Compiler Collection or Boost C++ libraries.

### Tableau-Based Approach: Generating a Tableau

It has been found that the arguments to the computational intensive functions mentioned above often fall within a fixed range (e.g., limited range) on the number line during run-time. With respect to a tableau-based approach, the system is configured for exploiting this run-time behavior to eliminate the call and execution of the computational intensive functions at run time. Specifically, the system is preferably configured for carrying out the tableau-based approach by carrying out the following steps:

A first step is to determine the argument range via application specification and program analysis. The argument range involves a value range, such as a consumer age range, a consumer location range, a product price range, among other things. A second step is to discretize the range into multiple intervals. (Discretization is discussed in more detail in a separate section below.) In many cases, this discretization may not be needed as the variable is practically a discrete variable. A third step is, for each discrete value v in the range, to calculate the value of the computational intensive function f(v). A fourth step is to store the value of f(v) in a tableau.

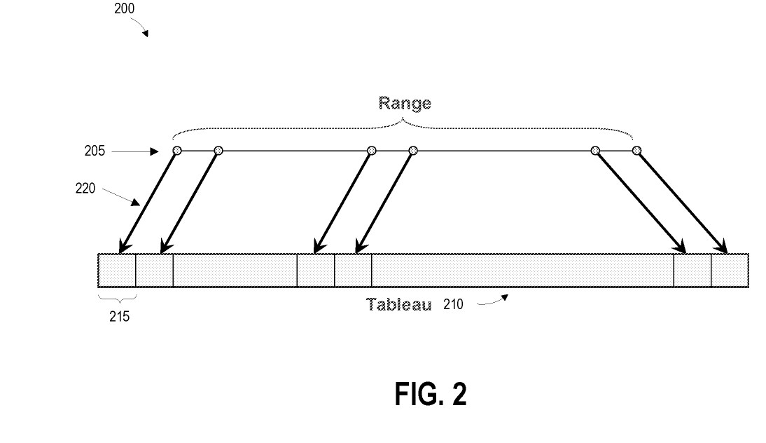

FIG. 2 illustrates the storage of discretized values 205 into a tableau 210, in accordance with some embodiments. The number of entries 220 in the tableau 210 is equal, or substantially equal, to the number of intervals 215 in the discretized range.

There are advantages of the tableau-based approach. A first advantage is that the computation of f(v) is done only once and the population of the tableau is done at start up or initialization time. (Recall that in the traditional case, f(v) is calculated at run time). A second advantage is that accessing the values from the tableau at run time can be done in O(1) time.

In contrast, given an argument x, computing the value of certain functions would be extremely computation intensive. An example of a function that is computation intensive is e^{x}. This computational intensiveness stems from the fact e^{x} is calculated as a Taylor series which in turn invokes the computation intensive power and factorial multiple routines. This Taylor series is given as Equation 2 below.

$$Taylor series for {e}^{x} \\ {e}^{x} = {\sum }_{n = 0}^{∞} \frac{{x}^{n}}{n !} = 1 + x + \frac{{x}^{2}}{2 !} + \frac{{x}^{3}}{3 !} + \frac{{x}^{4}}{4 !} + … . \qquad Equation 2$$

The two advantages of the tableau-based approach mentioned above directly benefit the run-time performance of the ad selection process. The system has been applied to a conventional ad serving application. It was found that the system achieved up to an 18% performance speedup in a production setting. Other performance increases are feasible, depending on the embodiment. The memory required for the tableau is dependent on the number of intervals in the range. This memory requirement may be relatively extremely small.

The tableau-based approach described above may also be extended to a non-fixed range (e.g. unlimited range). The values of the computational intensive function f(v), for intervals corresponding to the high frequency range, are stored in a tableau. The computational intensive function f(v) is calculated at run-time for intervals outside the high frequency range.

### Demand-Driven Selective Caching: Generating a Hash

In some cases, the arguments to the computational intensive functions may not be limited to a fixed range on the number line. For such scenarios, the system is configured for carrying out a technique based on demand-driven hashing.

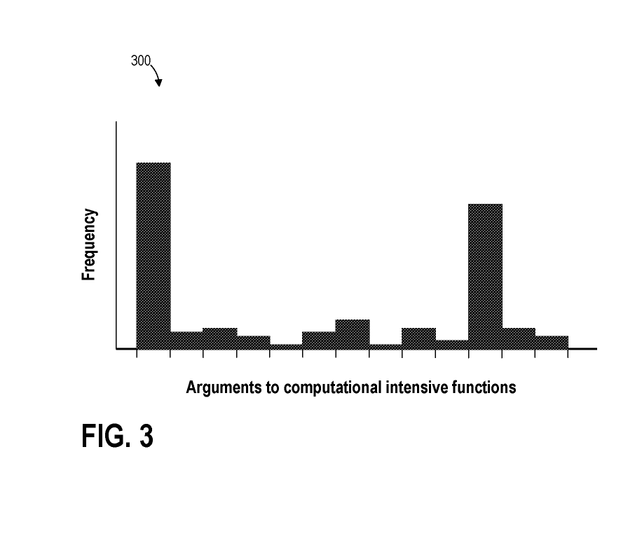

FIG. 3 is a distribution 300 of frequencies arguments to the computational intensive functions, in accordance with some embodiments. The design of the technique for demand-driven selective caching has its roots in the fact, illustrated in FIG. 3, that the arguments to the computational intensive functions do not have the same frequency of use. The system is configured for exploiting this fact in order to minimize calls to the computational intensive functions at run-time. Specifically, the system is preferably configured for carrying out the demand-driven selective caching by carrying out the following steps:

A first step is to discretize the argument space of the arguments of the computational intensive functions that are within a fixed range. (Discretization is discussed in more detail in a separate section below.) A second step is, given a computational intensive function, to determine a frequency distribution of the discretized argument space. The frequency distribution is obtaining by applying the computational intensive function to a training data set. A third step is to normalize the frequency distribution. A fourth step involves generating a hash. For example, let S denote the minimum set of intervals whose cumulative normalized frequency is greater than a predetermined number (e.g., 0.90) in order of highest frequency. Note that this predetermined number is a configurable parameter. The system generates a hash (e.g., <interval, f(interval)) corresponding to all the intervals in S.

These steps may require a large size hash which may adversely impact the memory performance. Accordingly, a fifth step may involve limiting the number of hash entries to a predetermined number. That predetermined number may be, for example, 1 million or any other number that allows a sufficient number of hashing while preserving acceptable memory performance. In the example above, if there are only 1 million hash entries, then an interval with a normalized frequency of less than 10⁻⁶ will not be hashed.

A sixth step involves evolves calculating the computational intensive function, f(v), every time for arguments for which there does not exist an entry in the hash. This calculating will likely have minimal impact on performance as the cumulative normative frequency of such arguments is relatively extremely low.

The two techniques (tableau-based approach and demand driven selective caching) described above facilitate the use of more complex and computation intensive functions like exponential functions and logarithmic functions. The system may carry out of these two techniques without a high computational cost or a high latency cost. The use of such complex functions in turn boosts ad relevance. Thus, the system is likely to have a direct impact on the bottom line (e.g., cost per ad) of a company like Yahoo®.

### More Details of Discretization

The performance of the system configured for using the two techniques (tableau-based approach and demand driven selective caching) described above depends on a multitude of factors. A first factor is discretization/quantization. The calculations performed in models to select ads with highest ad relevance and revenue generations require repetitive complex math computations. The arguments to these functions are usually not continuous variable and in practice have discrete values in a limited range.

A second factor is discretization granularity. Most arguments fed into complex math functions have some practical meaning like time and location, among other meanings. The value of the arguments need not be exact and the measured or assumed values are usually rounded to the limits of the measuring or monitoring system. The granularity may be decided by the impact on ad relevance or by the limiting factors that govern the data generation process. For example, in the context of geo-targeted ads, the lowest discrete value would correspond to the geographic resolution desired. This is analogous to currency wherein the lowest discrete value would correspond to the lowest denomination of the currency or to a fraction of the lowest denomination. There may also be other factors that affect the performance of the two techniques (tableau-based approach and demand driven selective caching).

### Applying the System to Various Forms of Online Advertising

The system for enabling high performance ad selection accounts for the different problem parameters in a platform-independent manner. Thus, the approach presented herein is not tied to any particular architecture for online advertising.

The aforementioned optimization technique for enabling high performance ad selection is run-time based. The technique does not require any special hardware. However, special hardware may be designed for the technique, depending on the embodiment.

A key aspect of the technique involves using a tableau (FIG. 2) and populating the tableau at about initialization time. The system is configured for then using the tableau, instead of making calls to libraries such libm, to obtain (not recalculate) the value of complex and computationally intensive functions. The optimizations that the system performs are transparent to the designer of the ad selection engine and the programmer.

The reduction in the ad selection processing time improves the key bottom line of cost of selecting one or more ads. The system improves the bottom line by enabling processing of a relatively large number of available ads per dollar of investment. Furthermore, the gains achieved are compounded by virtue of the fact that the ad selection processing is done over a computing cluster that may comprise, for example, tens of thousands of nodes. Thus, from a system-wide perspective, the impact of optimizing the speed of repetitive complex math functions on each node via the proposed technique would be much higher.

Specific advantages of the system are listed here. In a first advantage, the optimization technique presented herein improves consumer experience by reducing the response time to the consumer device when the consumer device accesses a website. This improved consumer experience is achieved by performing relatively faster selection, or substantially fast selection, of relevant ads. Improved user experience tends to attract relatively more consumer traffic to the website(s) being accessed. This higher traffic will in turn attract more advertisers that are interested in advertising on the website. The increase in advertiser drives increased monetization of advertising on the website.

In a second advantage, the system is applicable to substantially all forms of online advertising. The system is particularly useful for online advertising applications that are time-sensitive. Examples of time-sensitive online advertising applications include without limitation behavioral targeting, advertising involving large data sets, an ad exchange, organization of ad taxonomies, a substantially real-time event stream analysis, a substantially real-time ad auction, content targeted advertising, geo targeted advertising and local time targeted advertising, among other things. The ubiquitous nature of the system stems from the fact that the repetitive complex math functions form a core component of all the online advertising models. Thus, the system described herein is, by design, generic in nature.

In a third advantage, the lower computation time will result in lower CPU (central processing unit) consumption and as a result higher vertical scalability for the ad servers. This lower computation time translates into less number of ad servers needed for horizontal scaling.

In a fourth advantage, lower CPU utilization will result in higher capacity for ad servers and lower capital expenditure. These ad servers are usually run on hundreds if not thousands of servers.

In a fifth advantage, the overall optimization methodology proposed herein is decoupled with the specific algorithms selected for ad ranking and the models used to score and select an ad.

### Overview of Method for Enabling High Performance Ad Selection

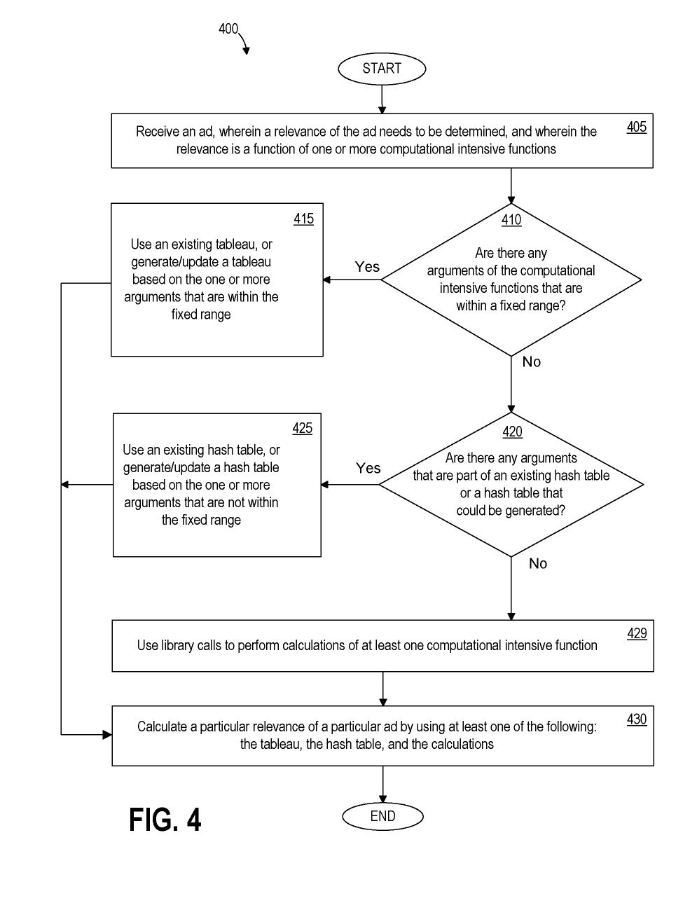

FIG. 4 is a flowchart of a method 400 for enabling high performance ad selection, in accordance with some embodiments. The steps of the method 400 may be carried out by one or more devices of the system 100 of FIG. 1. Any of the steps of the method 400 may be performed either during initialization time or during run time of an ad selection process.

The method 400 starts in a step 405 where the system receives an ad. A relevance of the ad needs to be determined. The relevance of the ad is a function of one or more computational intensive functions.

The method 400 then moves to a decision operation 410 where the system determines if there are any arguments of the computational intensive functions that are within a fixed range. If the system determines there are arguments that are within a fixed range, then the method 400 proceeds to a step 415 where the system uses an existing tableau, or generates/updates a tableau based on the arguments that are within the fixed range. A tableau preferably stores a solution for the computational intensive functions. The generation/update of a tableau may involve a number of steps, including without limitation determining the argument range, discretizing the argument range into multiple intervals, and computing the value of the computational intensive function for each discrete value in the argument range, among other steps. The method 400 then proceeds to a step 430.

However, in the decision operation 410, if the system determines there are no arguments that are within a fixed range, then the method 400 proceeds to a decision operation 420. In the decision operation 420, the system determines if there are any arguments of the computational intensive functions that are part of an existing hash table or a hash table that could be generated. If the system determines there are arguments that are part of an existing hash table or a hash table that could be generated, then the method 400 proceeds to a step 425 where the system uses an existing hash table, or generates/updates a hash table based on the arguments that are not within a fixed range. The generation/update of a hash table may involve a number of steps, including without limitation discretizing the argument space, determining the frequency distribution of the discretized argument space, and normalizing the frequency distribution, among other steps. The method 400 then proceeds to the step 430.

However, in the decision operation 420, if the system determines there are no arguments that are not within a fixed range, then the method 400 proceeds to a step 429. In the step 429, the system uses library calls to perform calculations of at least one computational intensive function. This calculating will likely have minimal impact on performance as the cumulative normative frequency of such arguments is relatively extremely low. The method 400 then proceeds to the step 430.

The system may receive a request to select an appropriate ad (e.g., message) for advertising on a website. To select an appropriate ad, the system may utilize the pre-generated tableau, the pre-generated hash table and/or the calculations of the computational intensive function. For example, the system may calculate a particular relevance of a particular ad. Specifically, in the step 430 of the method 400, the system calculates the particular relevance by using at least one of the following: the tableau, the hash, or a calculation of one or more computational intensive functions. For instance, the system may determine an ad to select by accessing the tableau to retrieve a solution for the one or more computational intensive functions with an argument within the fixed range. After the step 430, the method 400 concludes.

Note that the method 400 may include other details and steps that are not discussed in this method overview. Other details and steps are discussed with reference to the appropriate figures and may be a part of the method 400, depending on the embodiment.

### III.

### Exemplary Network, Client, Server and Computer Environments

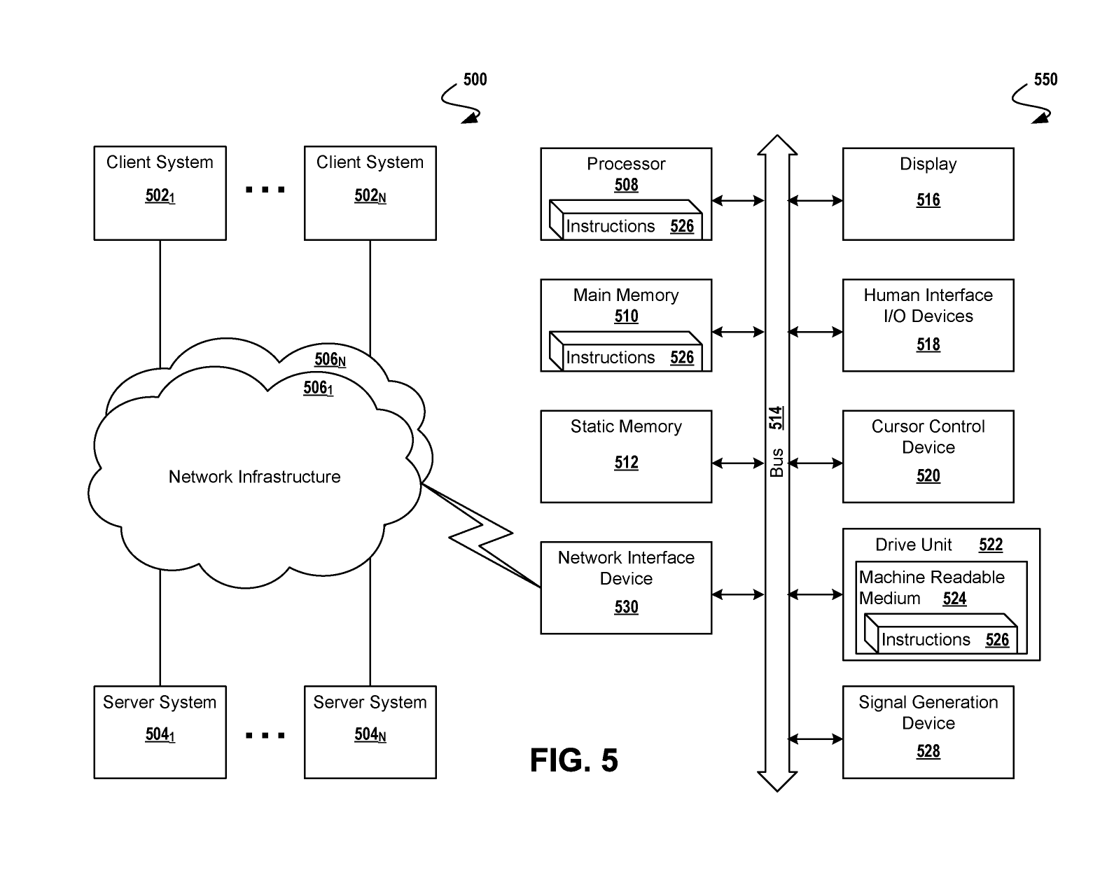

FIG. 5 is a diagrammatic representation of a network 500, including nodes for client systems 502₁ through 502_{N}, nodes for server systems 504₁ through 504_{N}, nodes for network infrastructure 506₁ through 506_{N}, any of which nodes may comprise a machine 550 within which a set of instructions, for causing the machine to perform any one of the techniques discussed above, may be executed. The embodiment shown is exemplary, and may be implemented in the context of one or more of the figures herein.

Any node of the network 500 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 550 includes a processor 508 (e.g., a processor core, a microprocessor, a computing device, etc.), a main memory 510 and a static memory 512, which communicate with each other via a bus 514. The machine 550 may further include a display unit 516 that may comprise a touch-screen, or a liquid crystal display (LCD), or a light emitting diode (LED) display, or a cathode ray tube (CRT). As shown, the computer system 550 also includes a human input/output (I/O) device 518 (e.g. a keyboard, an alphanumeric keypad, etc), a pointing device 520 (e.g., a mouse, a touch screen, etc), a drive unit 522 (e.g., a disk drive unit, a CD/DVD drive, a tangible computer readable removable media drive, an SSD storage device, etc.), a signal generation device 528 (e.g., a speaker, an audio output, etc.), and a network interface device 530 (e.g., an Ethernet interface, a wired network interface, a wireless network interface, a propagated signal interface, etc.).

The drive unit 522 includes a machine-readable medium 524 on which is stored a set of instructions 526 (e.g., software, firmware, middleware, etc.) embodying any one, or all, of the methodologies described above. The set of instructions 526 is also shown to reside, completely or at least partially, within the main memory 510 and/or within the processor 508. The set of instructions 526 may further be transmitted or received via the network interface device 530 over the network bus 514.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

### Advantages

The system enables high performance ad selection. The two techniques (tableau-based approach and demand driven selective caching) described above facilitate the use of more complex and computation intensive functions like exponential functions and logarithmic functions. The system may carry out of these two techniques without a high computational cost or a high latency cost. The use of such complex functions in turn boosts ad relevance. Thus, the system is likely to have a direct impact on the bottom line (e.g., cost per ad) of a company like Yahoo®.

The reduction in the ad selection processing time improves the key bottom line of cost of selecting an ad. The system improves the bottom line by enabling processing of a larger number of available ads per dollar of investment. Furthermore, the gains achieved are compounded by virtue of the fact that the ad selection processing is done over a cluster that may comprise, for example, tens of thousands of nodes. Thus, from a system-wide perspective, the impact of optimizing the speed of repetitive complex math functions on each node via the proposed technique would be much higher.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer-implemented method for enabling message selection, the method comprising:
identifying, at a computer, one or more computational intensive functions, and wherein a computational intensive function requires more than trivial processing to execute;
identifying, at a computer, one or more arguments of the computational intensive functions that are within a fixed range;
generating, at a computer, a tableau for the one or more arguments that stores a solution for the computational intensive functions;
receiving, at a computer, a request to select a message; and
determining, at a computer, a message to select by accessing the tableau to retrieve a solution for the one or more computational intensive functions with an argument within the fixed range.

2. The method of claim 1, further comprising:
identifying at the computer one or more arguments of the computational intensive functions that are not within a fixed range; and
generating at the computer a hash table of the one or more arguments that are not within a fixed range, wherein the hash is configured to benefit run-time performance of an message selection process whenever the computer accesses the hash table during run-time instead of calculating one or more computational intensive functions.

3. The method of claim 2, further comprising calculating a particular relevance of a particular message by using at least one of:
the tableau;
the hash; and
a calculation of at least one computational intensive function of the particular relevance.

4. The method of claim 1, wherein the generating the tableau comprises at least one of:
determining an argument range of an argument that is within the fixed range;
discretizing the argument range into multiple intervals;
calculating a value of a computational intensive function for each discrete value in the fixed range; and
store in the tableau each value of the computational intensive function.

5. The method of claim 2, wherein the generating the hash comprises at least one of:
discretizing the argument space of the arguments that are not within a fixed range in order to generate a discretized argument space;
determining a frequency distribution of the argument space by applying a given computational intensive function to a training data set;
normalizing the frequency distribution; and
generating a hash corresponding to all intervals in a minimum set of intervals whose cumulative normalized frequency is greater than a predetermined number in order of highest frequency.

6. The method of claim 1, wherein the method comprising at least one of:
reducing an message selection processing time;
processing a large number of available messages per dollar of investment in the available messages; and
improving a bottom line of cost of selecting one or more messages.

7. The method of claim 1, further comprising at least one of:
performing the message selection over a computing cluster including multiple nodes; and
optimizing a speed of repetitive complex math functions on each node of the computing cluster.

8. The method of claim 1, further comprising at least one of:
selecting relevant messages for a consumer device in a substantially fast manner;
improving a consumer experience by reducing a response time to the consumer device when the consumer device accesses a website;
attracting more consumer traffic to the website;
attracting more messaging customers that are interested in messaging on the website; and
increasing monetization of messaging on the website.

9. The method of claim 1, further comprising applying the method to online messaging that is time-sensitive.

10. The method of claim 9, wherein the online messaging that is time-sensitive includes at least one of:
behavioral targeting;
messaging involving large data sets;
an message exchange;
organization of an message taxonomies;
a substantially real-time event stream analysis;
a substantially real-time message auction;
content targeted messaging;
geo targeted messaging; and
local time targeted messaging.

11. A system for enabling message selection, the system comprising:
a computer system configured for:
identifying, at a computer, one or more computational intensive functions, and wherein a computational intensive function requires more than trivial processing to execute;
identifying, at a computer, one or more arguments of the computational intensive functions that are within a fixed range;
generating, at a computer, a tableau for the one or more arguments that stores a solution for the computational intensive functions;
receiving, at a computer, a request to select a message; and
determining, at a computer, a message to select by accessing the tableau to retrieve a solution for the one or more computational intensive functions with an argument within the fixed range.

12. The system of claim 11, wherein the computer system is further configured for:
identifying one or more arguments of the computational intensive functions that are not within a fixed range; and
generating a hash of the one or more arguments that are not within a fixed range, wherein the hash is configured to benefit run-time performance of an message selection process whenever the computer system accesses the hash during run-time instead of calculating one or more computational intensive functions.

13. The system of claim 12, wherein the computer system is further configured for calculating a particular relevance of a particular message by using at least one of:
the tableau;
the hash; and
a calculation of at least one computational intensive function of the particular relevance.

14. The system of claim 11, wherein the generating the tableau comprises at least one of:
determining an argument range of an argument that is within the fixed range;
discretizing the argument range into multiple intervals;
calculating a value of a computational intensive function for each discrete value in the fixed range; and
store in the tableau each value of the computational intensive function.

15. The system of claim 12, wherein the generating the hash comprises at least one of:
discretizing the argument space of the arguments that are not within a fixed range in order to generate a discretized argument space;
determining a frequency distribution of the argument space by applying a given computational intensive function to a training data set;
normalizing the frequency distribution; and
generating a hash corresponding to all intervals in a minimum set of intervals whose cumulative normalized frequency is greater than a predetermined number in order of highest frequency.

16. The system of claim 11, wherein the computer system is further configured for at least one of:
reducing an message selection processing time;
processing a large number of available messages per dollar of investment in the available messages; and
improving a bottom line of cost of selecting one or more messages.

17. The system of claim 11, wherein the computer system is configured for at least one of:
performing the message selection over a computing cluster including multiple nodes; and
optimizing a speed of repetitive complex math functions on each node of the computing cluster.

18. The system of claim 11, wherein the computer system is configured for at least one of:
selecting relevant messages for a consumer device in a substantially fast manner;
improving a consumer experience by reducing a response time to the consumer device when the consumer device accesses a website;
attracting more consumer traffic to the website;
attracting more messaging customers that are interested in messaging on the website; and
increasing monetization of messaging on the website.

19. The system of claim 11, wherein the sever system is configured for applying the system to online messaging that is time-sensitive.

20. The system of claim 19, wherein the online messaging that is time-sensitive includes at least one of:
behavioral targeting;
messaging involving large data sets;
an message exchange;
organization of message taxonomies;
a substantially real-time event stream analysis;
a substantially real-time message auction;
content targeted messaging;
geo targeted messaging; and
local time targeted messaging.

21. A computer readable medium comprising one or more instructions for enabling ad selection, wherein the one or more instructions are configured for causing the one or more processors to perform the steps of:
identifying, at a computer, one or more computational intensive functions, and wherein a computational intensive function requires more than trivial processing to execute;
identifying, at a computer, one or more arguments of the computational intensive functions that are within a fixed range;
generating, at a computer, a tableau for the one or more arguments that stores a solution for the computational intensive functions;
receiving, at a computer, a request to select a message; and
determining, at a computer, a message to select by accessing the tableau to retrieve a solution for the one or more computational intensive functions with an argument within the fixed range.
